(19) United States
(12) Patent Application Publication
(10) Pub. No.: US 2007/0026373 A1
(43) Pub. Date: Feb. 1, 2007

(54) Resource replication service protocol

(75) Inventors: Guhan Suriyanarayanan, Redmond, WA (US); Nikolaj S. Bjorner, Woodinville, WA (US); Rafik M. W. Robeal, Redmond, WA (US); Shi Cong, Issaquah, WA (US); Joseph A. Porkka, Bellevue, WA (US); Christophe F. Robert, Newcastle, WA (US); Dan Teodosiu, Kirkland, WA (US); David Golds, Redmond, WA (US); Huisheng Liu, Sammamish, WA (US); Shobana M. Balakrishnan, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/266,515

(22) Filed: Nov. 2, 2005

Related U.S. Application Data
(60) Provisional application No. 60/702,805, filed on Jul. 26, 2005.

(51) Int. Cl. G09B 3/00; G09B 7/00

(52) U.S. Cl. 434/322

(57) ABSTRACT

Aspects of the subject matter described herein relate to replicating resources across machines participating in a replica set. In aspects, a downstream machine requests that an upstream machine notify the downstream machine when updates to resources of the replica set occur. When such updates occur, the upstream machine notifies the downstream machine. In response thereto, the downstream machine requests resource meta-data and may include a limit as to how much resource meta-data may be sent. The upstream machine responds with the requested resource meta-data. Thereafter, the downstream machine determines which data associated with the updated resources to request and requests such data.

### BACKGROUND

Systems for replicating resources are becoming increasingly important to ensure availability and fault tolerance in large networks. Corporate networks that replicate files containing domain credentials and policies are one example where availability, scalability, consistency, and reliability are critical. These requirements do not necessarily interact in a cooperative manner.

### SUMMARY

Briefly, aspects of the subject matter described herein relate to replicating resources across machines participating in a replica set. In aspects, a protocol is described in which a downstream machine requests that an upstream machine notify the downstream machine when updates to resources of the replica set occur. When such updates occur, the upstream machine notifies the downstream machine. In response thereto, the downstream machine requests resource meta-data and may include a limit as to how much resource meta-data may be sent. The upstream machine responds with the requested resource meta-data. Thereafter the downstream machine determines which data associated with the updated resources to request and requests such data.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “one or more aspects”. Identifying aspects of the subject matter described in the Detailed Description is not intended to identify key or essential features of the claimed subject matter.

The aspects described above and other aspects will become apparent from the following Detailed Description when taken in conjunction with the drawings, in which:

### BRIEF DESCRIPTION OF THE DRAWINGS

FIG. 1 is a block diagram representing a computer system into which aspects of the subject matter described herein may be incorporated;

FIGS. 2A-6B are block diagrams generally representing exemplary application programming interfaces that may operate in accordance with aspects of the subject matter described herein;

FIGS. 7 and 8 are block diagrams that generally represent how a compiler or interpreter may transform one or more interfaces to one or more other interfaces in accordance with aspects of the subject matter described herein;

FIG. 9 is a block diagram that generally represents interactions between a source and a destination machine in accordance with aspects of the subject matter described herein;

FIG. 10 is a timing diagram that illustrates an exemplary flow of events that may occur when replicating resources in accordance with aspects of the subject matter described herein;

FIG. 11 is a flow diagram that generally represents actions that may occur in synchronizing from a downstream machine's perspective in accordance with various aspects of the subject matter described herein;

FIG. 12 is a flow diagram that generally represents actions that may occur in synchronizing from an upstream machine's perspective in accordance with various aspects of the subject matter described herein; and

FIG. 13 is a block diagram representing a machine configured to operate in a resource replication system in accordance with aspects of the subject matter described herein.

### DETAILED DESCRIPTION

Exemplary Operating Environment

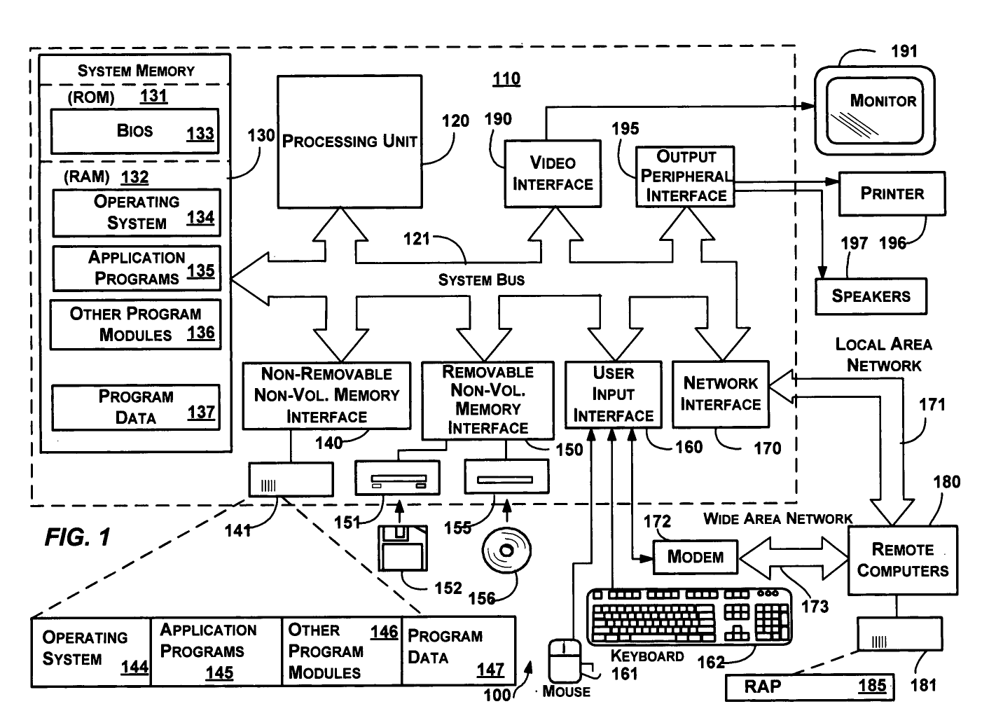

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Interfaces

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), and the like of a component of a system capable of communicative coupling to one or more mechanism(s), method(s), function call(s), module(s), and the like of other component(s). The term “segment of code” is intended to include one or more instructions or lines of code, and includes, for example, code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

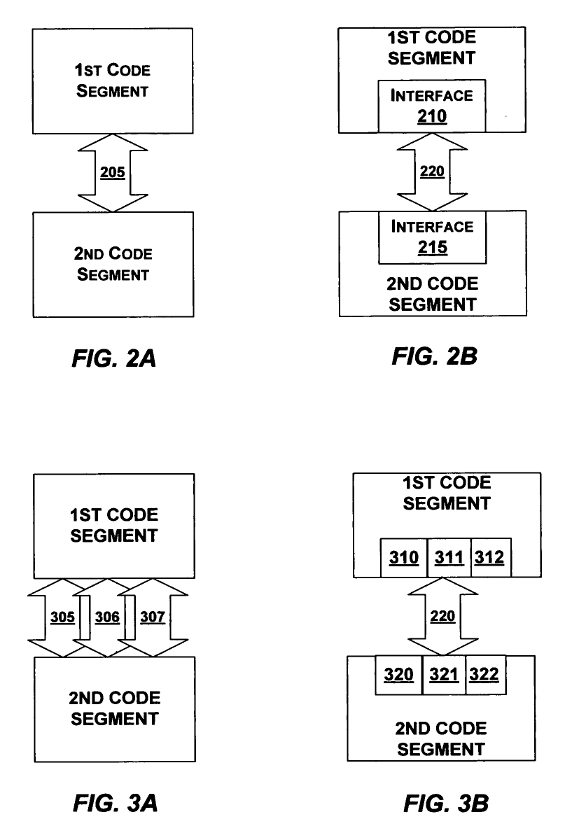

Notionally, a programming interface may be viewed generically, as shown in FIG. 2A or FIG. 2B. FIG. 2A illustrates an interface 205 as a conduit through which first and second code segments communicate. FIG. 2B illustrates an interface as comprising interface objects 210 and 215 (which may or may not be part of the first and second code segments), which enable first and second code segments of a system to communicate via medium 220. In the view of FIG. 2B, one may consider interface objects 210 and 215 as separate interfaces of the same system and one may also consider that objects 210 and 215 plus medium 220 comprise the interface. Although FIGS. 2A and 2B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment simply accesses functionality performed by a second code segment. Any or all of these aspects may be important in a given situation, for example, depending on whether the code segments are part of a system in a loosely coupled or tightly coupled configuration, and so this list should be considered illustrative and non-limiting.

This notion of a programming interface is known to those skilled in the art and is clear from the foregoing detailed description. There are, however, other ways to implement a programming interface, and, unless expressly excluded, these too are intended to be encompassed by the claims set forth at the end of this specification. Such other ways may appear to be more sophisticated or complex than the simplistic view of FIGS. 2A and 2B, but they nonetheless perform a similar function to accomplish the same overall result. Below are some illustrative alternative implementations of a programming interface.

A. Factoring

A communication from one code segment to another may be accomplished indirectly by breaking the communication into multiple discrete communications. This is depicted schematically in FIGS. 3A and 3B. As shown, some interfaces can be described in terms of divisible sets of functionality. Thus, the interface functionality of FIGS. 2A and 2B may be factored to achieve the same result, just as one may mathematically provide 24 as 2 times 2 times 3 times 2. Accordingly, as illustrated in FIG. 3A, the function provided by interface 205 may be subdivided to convert the communications of the interface into multiple interfaces 305, 306, 307, and so on while achieving the same result.

As illustrated in FIG. 3B, the function provided by interface 210 may be subdivided into multiple interfaces 310, 311, 312, and so forth while achieving the same result. Similarly, interface 215 of the second code segment which receives information from the first code segment may be factored into multiple interfaces 320, 321, 322, and so forth. When factoring, the number of interfaces included with the 1^{st} code segment need not match the number of interfaces included with the 2^{nd} code segment. In either of the cases of FIGS. 3A and 3B, the functional spirit of interfaces 205 and 210 remain the same as with FIGS. 2A and 2B, respectively.

The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

B. Redefinition

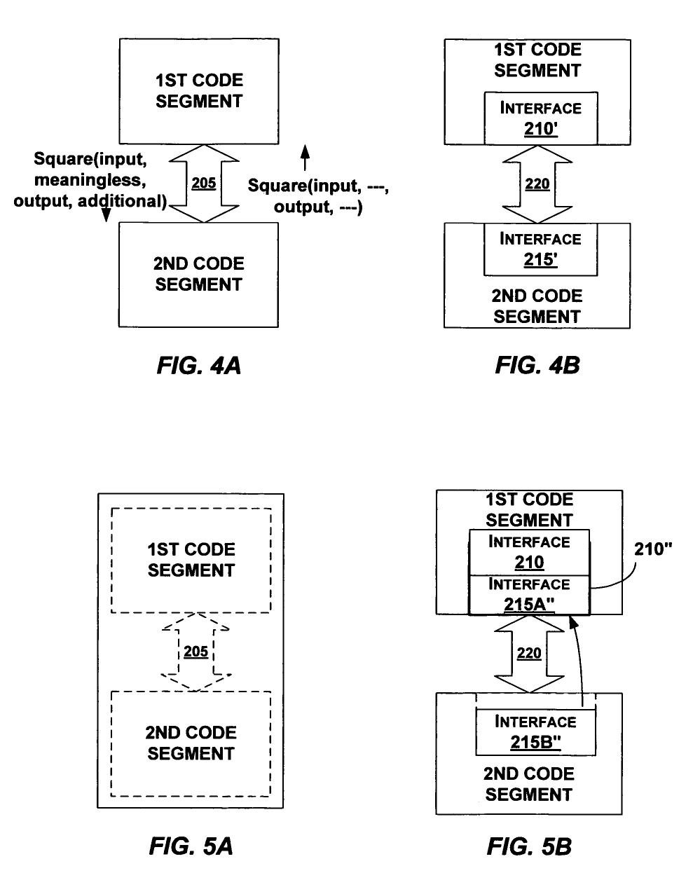

In some cases, it may be possible to ignore, add, or redefine certain aspects (e.g., parameters) of a programming interface while still accomplishing the intended result. This is illustrated in FIGS. 4A and 4B. For example, assume interface 205 of FIG. 2A includes a function call Square (input, precision, output), that includes three parameters, input, precision and output, and which is issued from the 1^{st} Code Segment to the 2^{nd} Code Segment. If the middle parameter precision is of no concern in a given scenario, as shown in FIG. 4A, it could just as well be ignored or even replaced with a meaningless (in this situation) parameter. An additional parameter of no concern may also be added. In either event, the functionality of square can be achieved, so long as output is returned after input is squared by the second code segment.

Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 4B, interface 210 is replaced by interface 210′, redefined to ignore or add parameters to the interface. Interface 215 may similarly be redefined as interface 215′, redefined to ignore unnecessary parameters, or parameters that may be processed elsewhere. As can be seen, in some cases a programming interface may include aspects, such as parameters, that are not needed for some purpose, and so they may be ignored or redefined, or processed elsewhere for other purposes.

C. Inline Coding

It may also be feasible to merge some or all of the functionality of two separate code modules such that the “interface” between them changes form. For example, the functionality of FIGS. 2A and 2B may be converted to the functionality of FIGS. 5A and 5B, respectively. In FIG. 5A, the previous 1^{st} and 2^{nd} Code Segments of FIG. 2A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface 205 may still be in effect. Similarly, shown in FIG. 5B, part (or all) of interface 215 from FIG. 2B may be written inline into interface 210 to form interface 210″. As illustrated, interface 215 is divided into 215A″ and 215B″, and interface portion 215A″ has been coded in-line with interface 210 to form interface 210″.

For a concrete example, consider that the interface 210 from FIG. 2B may perform a function call square (input, output), which is received by interface 215, which after processing the value passed with input (to square it) by the second code segment, passes back the squared result with output. In such a case, the processing performed by the second code segment (squaring input) can be performed by the first code segment without a call to the interface.

D. Divorce

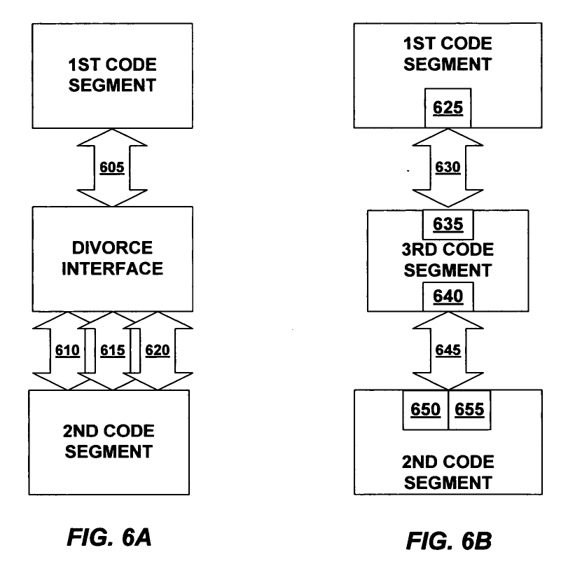

A communication from one code segment to another may be accomplished indirectly by breaking the communication into multiple discrete communications. This is depicted schematically in FIGS. 6A and 6B. As shown in FIG. 6A, one or more piece(s) of middleware (Divorce Interface(s), since they divorce functionality and/or interface functions from the original interface) are provided to convert the communications on the first interface 605, to conform them to a different interface, in this case interfaces 610, 615, and 620. This might be done, for example, where there is an installed base of applications designed to communicate with, say, an operating system in accordance with an the first interface 605's protocol, but then the operating system is changed to use a different interface, in this case interfaces 610, 615, and 620. It can be seen that the original interface used by the 2^{nd} Code Segment is changed such that it is no longer compatible with the interface used by the 1^{st} Code Segment, and so an intermediary is used to make the old and new interfaces compatible.

Similarly, as shown in FIG. 6B, a third code segment can be introduced with divorce interface 635 to receive the communications from interface 630 and with divorce interface 640 to transmit the interface functionality to, for example, interfaces 650 and 655, redesigned to work with 640, but to provide the same functional result. Similarly, 635 and 640 may work together to translate the functionality of interfaces 210 and 215 of FIG. 2B to a new operating system, while providing the same or similar functional result.

E. Rewriting

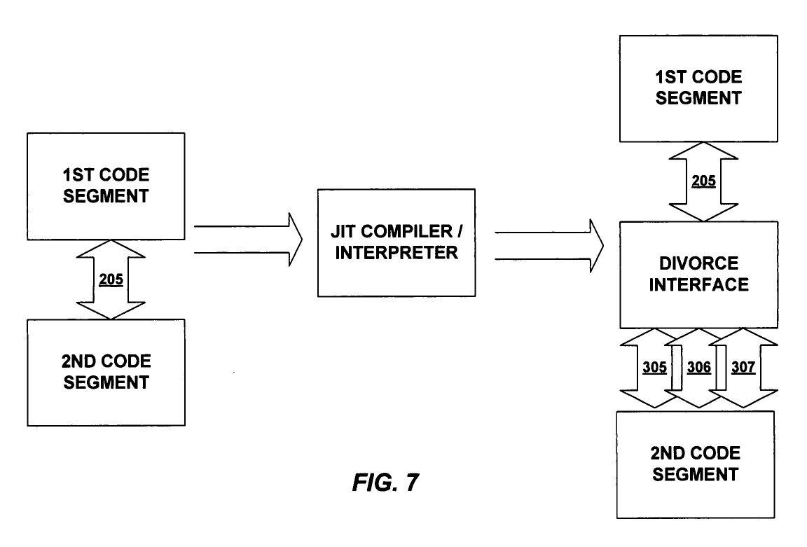

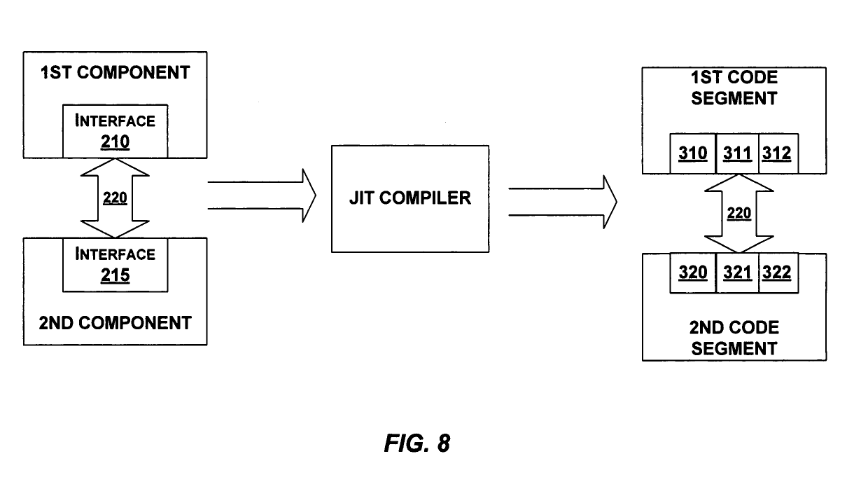

Yet another possible variant is to dynamically rewrite the code to replace the interface functionality with something else but which achieves the same overall result. For example, there may be a system in which a code segment presented in an intermediate language (e.g. Microsoft IL, Java® ByteCode, etc.) is provided to a Just-in-Time (JIT) compiler or interpreter in an execution environment (such as that provided by the net framework, the Java® runtime environment, or other similar runtime type environments). The JIT compiler may be written so as to dynamically convert the communications from the 1^{st} Code Segment to the 2^{nd} Code Segment, i.e., to conform them to a different interface as may be required by the 2^{nd} Code Segment (either the original or a different 2^{nd} Code Segment). This is depicted in FIGS. 7 and 8.

As can be seen in FIG. 7, this approach is similar to the Divorce scenario described above. It might be done, for example, where an installed base of applications are designed to communicate with an operating system in accordance with a first interface protocol, but then the operating system is changed to use a different interface. The JIT Compiler may be used to conform the communications on the fly from the installed-base applications to the new interface of the operating system. As depicted in FIG. 8, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched, and combined to produce the same or equivalent scenarios to the generic scenarios presented in FIGS. 2A and 2B. It is also noted that, as with most programming constructs, there are other similar ways of achieving the same or similar functionality of an interface which may not be described herein, but nonetheless are represented by the spirit and scope of the subject matter described herein, i.e., it is noted that it is at least partly the functionality represented by, and the advantageous results enabled by, an interface that underlie the value of an interface.

File Replication

As will readily be appreciated, modern machines may process thousands of resource changes in a relatively short period of time. Replicating these resources and keeping them synchronized across hundreds or thousands of machines connected via various networks of varying reliability and bandwidth benefit from an efficient protocol.

Opportunistic, multi-master replication systems allow unrestricted changes to replicated content on any machine participating in a given replica set. A replica set comprises a set of resources which are replicated on machines participating in the replica set. The set of resources of a replica set may span volumes. For example, a replica set may include resources associated with C:\DATA, D:\APPS, and E:\DOCS which may be replicated on a set of machines participating in the replica set. Potentially conflicting changes are reconciled under the control of the replication system using a set of conflict resolution criteria that defines, for every conflict situation, which conflicting change takes precedence over others.

The term “machine” is not limited simply to a physical machine. Rather, a single physical machine may include multiple virtual machines. Replication from one machine to another machine, as used herein, implies replication of one or more members of the same replica set from one machine, virtual or physical, to another machine, virtual or physical. A single physical machine may include multiple members of the same replica set. Thus, replicating members of a replica set may involve synchronizing the members of a single physical machine that includes two or more members of the same replica set.

A resource may be thought of as an object. Each resource is associated with resource data and resource meta-data. Resource data may include content and attributes associated with the content while resource meta-data includes other attributes that may be relevant in negotiating synchronization and in conflict resolution. Resource data and meta-data may be stored in a database or other suitable store; in an alternate embodiment, separate stores may be used for storing resource data and meta-data.

In replication systems including data stores based on named files in a file system, resource data may include file contents, as well as any file attributes that are stored on the file system in association with the file contents. File attributes may include access control lists (ACLs), creation/modification times, and other data associated with a file. In replication systems including data stores not based on named files in a file system (e.g., ones in which resources are stored in a database or object-based data store), resource data appropriate to the data store is stored. Throughout this document, replication systems based on files in a file system are often used for illustration, but it will be recognized that any data store capable of storing content may be used without departing from the spirit or scope of the subject matter described herein.

For each resource, resource meta-data may include a globally unique identifier (GUID), whether the resource has been deleted, a version sequence number together with authorship of a change, a clock value to reflect the time a change occurred, and other fields, such as a digest that summarizes values of resource data and may include signatures for resource content. A digest may be used for a quick comparison to bypass data-transfer during replication synchronization, for example. If a resource on a destination machine is synchronized with content on a source machine (e.g., as indicated by a digest), network overhead may be minimized by transmitting just the resource meta-data, without transmitting the resource data itself. Transmitting the resource meta-data is done so that the destination machine may reflect the meta-data included on the source machine in its subsequent replication activities. This may allow the destination machine, for example, to become a source machine in a subsequent replication activity. Resource meta-data may be stored with or separate from resource data without departing from the spirit or scope of the subject matter described herein.

Version vectors may be used when replicating resources. A version vector may be viewed as a global set of counters or clocks of machines participating in a replica set. Each machine participating in the replica set maintains a version vector that represents the machine's current latest version and the latest versions that the machine has received with respect to other machines. Each time a resource is created, modified, or deleted from a machine, the resource's version is set to a version number equivalent to the current version number for that machine plus one. The version vector for that machine is also updated to reflect that the version number for that machine has been incremented.

During synchronization, a version vector may be transmitted for use in synchronizing files. For example, if machines A and B engage in a synchronization activity such as a join, machine B may transmit its version vector to A. Upon receiving B's version vector, A may then transmit changes for all resources, if any, that have versions not subsumed by B's version vector. Examples of use of version vectors in synchronization have been described in U.S. patent application Ser. No. 10/791,041 entitled “Interval Vector Based Knowledge Synchronization for Resource Versioning”, U.S. patent application Ser. No. 10/779,030 entitled “Garbage Collection of Tombstones for Optimistic Replication Systems”, and U.S. patent application Ser. No. 10/733,459 entitled, “Granular Control Over the Authority of Replicated Information via Fencing and UnFencing.”

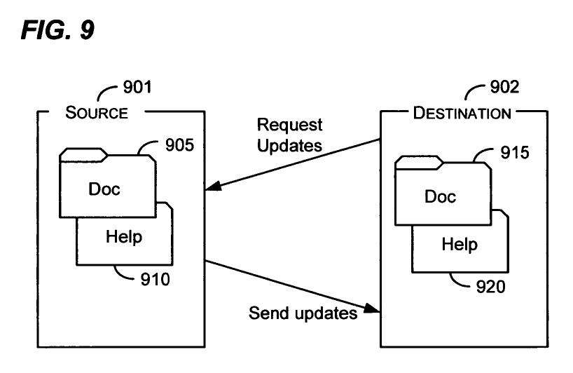

FIG. 9 is a block diagram that generally represents interactions between a source and a destination machine in accordance with aspects of the subject matter described herein. As an example, a source machine 901 and a destination 902 machine may participate in a replica set that includes two resources. These two resources may include, for example, documents directories 905 and 915 and help directories 910 and 920 (which are given different number on the two machines to indicate that at a particular moment in time, these resources may not include the same resource data—i.e., they may be out-of-sync).

As explained in more detail below, at some point the destination machine may request updates from the source machine and may update its files based on the updates. Although only two machines are shown in FIG. 9, the source and destination machines 901 and 902 may be part of a replication system that includes many other machines. A machine that is a source in one interaction (sometimes called an upstream machine) may later become a destination (sometimes called a downstream machine) in another interaction and vice versa.

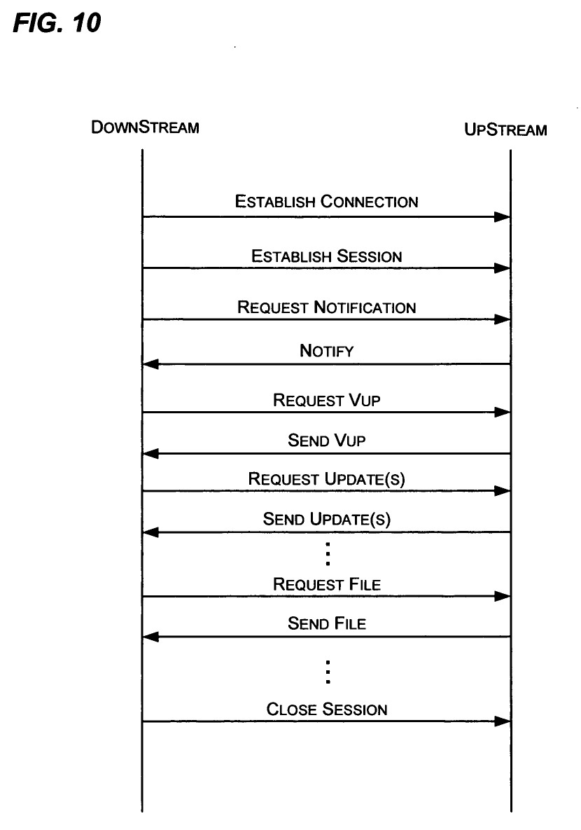

FIG. 10 is a timing diagram that illustrates an exemplary flow of events that may occur when replicating resources in accordance with aspects of the subject matter described herein. A downstream machine may establish a connection with an upstream machine (represented by “Establish Connection”for a replica set in which both the upstream and downstream machines participate. In establishing the connection each of the partners (i.e., the upstream and downstream machines) may send its version vector to the other partner. Then, a session is established (represented by “Establish Session”) to send updates from the upstream machine to the downstream machine.

A session may be used to bind a replicated folder of an upstream machine with its corresponding replicated folder of a downstream machine. A session may be established for each replicated folder of a replica set. The sessions for multiple folders may be established over a single connection between the upstream and downstream machines.

After all updates from a session have been processed or abandoned, the downstream closes the session (represented by “Close Session”).

The downstream machine requests (represented by “Request Notification”) that the upstream machine notify the downstream machine when updates for any resources associated with the session occur. When the upstream machine notifies (represented by “Notify”) the downstream machine that updates are available, the downstream machine requests the version vector for the updates (represented by “Request VVup”). In response the upstream machines sends its version vector (represented by “Send VVup”). Note that VVup may include a complete version vector or a version vector that includes changes since the last version vector was sent. Notifying the downstream machine that updates are available and waiting for the downstream machine to request the updates may be performed in two steps so that a downstream machine is not accidentally flooded with version vectors from multiple upstream partners.

The downstream machine uses the upstream version vector it receives (i.e., “VVup”) and computes a set-difference with its own version vector to compute versions residing on the upstream machine of which the downstream machine is unaware. The downstream machine may then request meta-data regarding the versions (represented by “Request Update(s)”). In requesting the updates, the downstream machine may include a delta version vector that indicates which updates the downstream machine needs and may also indicate how many updates may be sent by the upstream machine. The upstream machine may send up to the number of updates (represented by “Send Update(s)” and may include an offset (or cursor) in its response that indicates which update the upstream machine was able to get to in sending updates (for use when the updates available exceed the number of updates the downstream machine has requested). Afterwards, the downstream machine may request another batch of updates and may include the offset. This requesting of more than one batch of updates is represented by the ellipses beneath Send Update(s). This has an effect of throttling the number of updates to the number indicted by the downstream machine.

A downstream machine may request for tombstones or live updates separately or together. A tombstone represents that a resource has been deleted and live updates represent updates that do not delete a resource. In some implementations, the downstream machine may request tombstones before it requests live updates. This may be done to improve efficiency as a resource that has been modified and then deleted does not need to be modified before it is deleted on a replication partner. In addition, processing a tombstone before a live update may clear a namespace of the resource replication store of the downstream machine in preparation for processing a live replacement update.

After receiving one or more batches of updates, the downstream machine may begin processing the updates to determine which resource data or portion thereof associated with the updates to request from the upstream machine. For example, an update may indicate that a file or portion thereof has been changed. In one embodiment, the entire file may be requested by the downstream machine. In another embodiment, a portion of the file that includes the change may be requested by the downstream machine. As used herein, an interaction (e.g., request, response, update, and so forth) involving resource data should be understood to mean an interaction involving a portion or all of the resource data associated with a resource. For example, a request for resource data may mean a request for a portion or all of the resource data associated with a resource.

After determining a resource data that needs to be requested, the downstream machine may request the resource data (represented as “Request File”). In response, to a request for resource data, the upstream machine may send the resource data (represented as “Send File”) associated with a resource. Requests and responses may continue until all resource data which the destination machine has determined needs to be updated has been requested. This is represented by the ellipses beneath Send File. Note, that not all resource data may be sent as an upstream machine may no longer have a requested resource data if the resource has been deleted, for example. Another example in which resource data may not be sent is if the only effective change relative to the downstream machine is that the resource was renamed or that meta-data attributes were updated. In such cases, receiving the update and renaming a local resource or updating local meta-data may be all that is needed to synchronize the downstream resource with the upstream resource.

A session may be closed (represented by “Close Session”), for example, if a replicated folder is deleted, if a non-recoverable error occurs during replication, or if a replication system is shut down. Otherwise, the established session may be used for subsequent synchronization actions that involve all or a portion of the events above. Although Close Session is shown at the bottom of the timing diagram, in an embodiment it may be reached at any time as a non-recoverable error may occur or the replication system may be shut down without warning.

It should be noted that in one embodiment, establishing a connection and one or more sessions are performed synchronously while the other actions are performed asynchronously with respect to each other. In this sense, synchronously means that a requesting process or thread waits until the responding process or thread responds before continuing whereas asynchronously means that the requesting process or thread makes a request and is then free to do whatever else it wants to until the responding process or thread responds, which may be any time after the requesting process or thread makes the request.

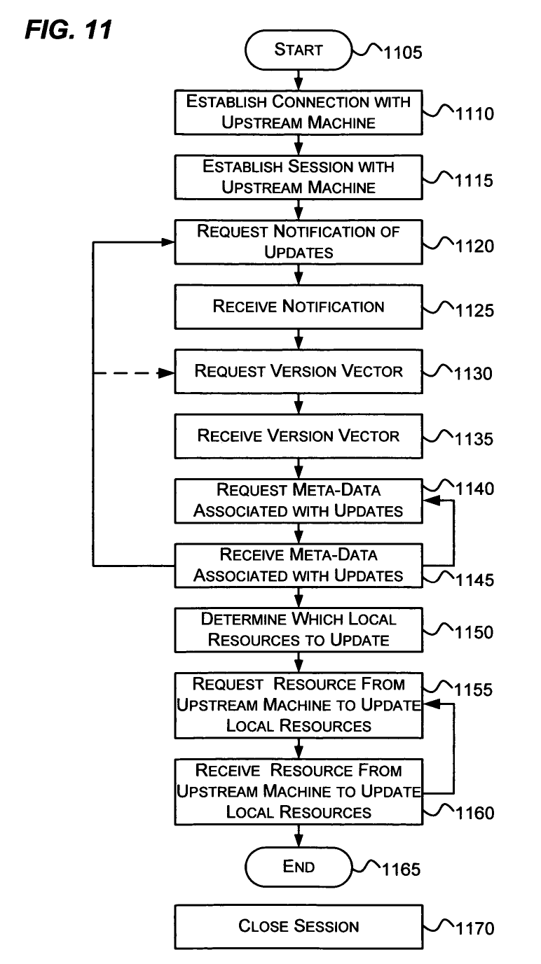

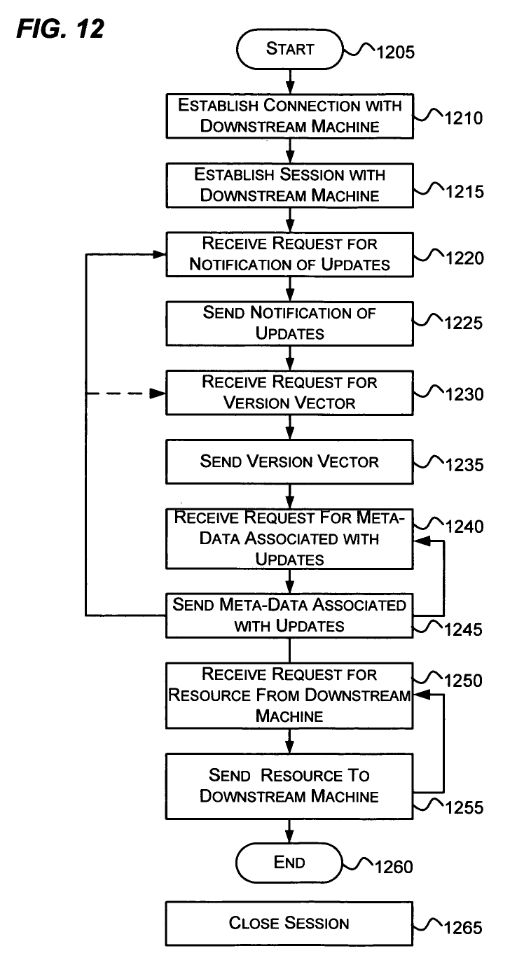

As described below in conjunction with FIGS. 11 and 12 two or more of the events described above may happen in parallel.

FIG. 11 is a flow diagram that generally represents actions that may occur in synchronizing from a downstream machine's perspective in accordance with various aspects of the subject matter described herein. At block 1105, the actions begin.

At block 1110, a connection is established with an upstream machine.

At block 1115, a session is established with the upstream machine. In some embodiments, a session is established with the upstream machine after notification is received that updates have been received. In these embodiments, the actions associated with block 1115 may occur between block 1125 and block 1130.

At block 1120, the downstream machine requests notification of updates. Afterwards, at block 1125, the downstream machine receives notification that updates have been received.

At block 1130, the downstream machine requests a version vector from the upstream machine so that the downstream machine may determine which resources on the upstream machine have been updated. The downstream machine may request a full version vector or a delta version vector than includes changes since the last version vector was received. At block 1135, the downstream machine receives the version vector.

At block 1140, the downstream machine requests meta-data associated with the updates. The meta-data may be divided into records, with each record corresponding to a particular resource. As previously mentioned, the downstream machine may also send a parameter that indicates a maximum number of records of meta-data that may be sent at one time.

At block 1145, the downstream machine receives the meta-data up to the maximum requested. If not all of the meta-data has been received, the actions continue at block 1140, and may also continue at block 1120 or block 1130 as described below; otherwise, the actions continue at block 1150.

At block 1150, the downstream machine uses the received meta-data to determine which local resources to update. This may involve applying some update conflict logic.

At block 1155, the downstream machine requests resource data (sometimes referred to as “a resource”) from the upstream machine. At block 1160, the downstream machine receives the resource data. The downstream machine may then use the resource data to update a resource local to the downstream machine. If more resources are to be updated, the actions continue at block 1155; otherwise, the actions continue at block 1165.

At block 1165, one set of actions (e.g., resource data for a requested resource may have been received) may end while other actions that have been occurring in parallel as described below may continue.

At block 1170, session may be closed as indicated previously. Block 1170 may be reached from any of the blocks above.

In some implementations, actions associated with the various blocks of FIG. 11 may proceed in parallel. For example, after receiving some of the meta-data at block 1145, more meta-data may be requested at block 1140 while the actions associated with blocks 1150-1160 are also performed.

In addition, the downstream machine may not need to determine all local resources to update at block 1150 before starting the actions at block 1155. For example, after the downstream machine determines one resource that needs to be updated, the actions may continue in parallel at block 1150, where the downstream machine attempts to determine what other local resources to update, and at blocks 1155-1160, where the downstream machine begins requesting and receiving one or more resources which it determined needed to be updated.

In an embodiment, after a downstream machine receives a first or other batch of meta-data at block 1145, the downstream machine may again request notification of updates (e.g., the actions associated with block 1120) while performing actions as sociated with blocks 1150-1165. Another notification may be received at block 1130 while the downstream machine is processing updates related to one or more previous updates.

The downstream machine may also request and receive updates in parallel requests from multiple upstream machines thus causing actions to occur in parallel.

Furthermore, some of the actions may be omitted in embodiments. For example, in one embodiment, a downstream machine may request that the upstream machine send a version vector without sending a notification whenever updates occur on the upstream machine. In this case, the actions associated with blocks 1120 and 1125 may be omitted. In another embodiment, automatically sending the version vector when updates occur may comprise notification that updates have occurred (and may be used to eliminate an additional request).

Requesting that an upstream partner send its version vector when updates occur, may be useful, for example, if the downstream machine has relatively few upstream partners associated with it. With relatively few upstream partners, the possibility of being flooded by upstream version vectors may be reduced or eliminated.

FIG. 12 is a flow diagram that generally represents actions that may occur in synchronizing from an upstream machine's perspective in accordance with various aspects of the subject matter described herein. At block 1205, the actions begin.

At block 1210, a connection is established with a downstream machine.

At block 1215, a session is established with the downstream machine. In some embodiments, a session is established with the downstream machine after notification of updates is sent to the downstream machine. In these embodiments the actions associated with block 1215 may occur between block 1225 and block 1230.

At block 1220, the upstream machine receives a request for notification of updates. Sometime afterwards (and after one or more updates have occurred), at block 1225, the upstream machine sends notification of updates to the downstream machine.

At block 1230, the upstream machine receives a request for the upstream machine's version vector. A request may indicate that either a full version vector or a delta version vector be sent. A downstream machine may use the full or delta version vector to determine which resources on the upstream machine have been updated. At block 1235, the upstream machine sends the version vector.

At block 1240, the upstream machine receives a request for meta-data associated with the updates. The meta-data may be divided into records, with each record corresponding to a particular resource. As previously mentioned, the request may include a parameter that indicates a maximum number of records of meta-data that may be sent at one time. The request may also include an off set that indicates the starting record which should be sent.

At block 1245, the upstream machine sends the meta-data up to the maximum requested. If not all of the meta-data has been sent and a request for more meta-data is received, the actions continue at block 1240 and may also continue at blocks 1220 or 1230 as described below; otherwise, the actions continue at block 1250.

At block 1250, the upstream machine receives a request for resource data. At block 1255, the upstream machine sends the resource data. The downstream machine may then use the resource data to update a resource local to the downstream machine. If more resources are to be updated, the actions continue at block 1250; otherwise, the actions continue at block 1260.

The downstream machine may decide to cancel obtaining the resource data for any particular resource. For example if a parent of the resource (e.g., a directory) has been deleted or missing, a child of a resource is live (e.g., an child of a directory has not been deleted), or for various other reasons, a downstream machine may decide to cancel obtaining the resource data for a particular resource. The downstream may inform the upstream machine of the cancellation and may also provide a reason therefor.

At block 1260, one set of actions (e.g., resource data for a requested resource may be sent) may end while other actions that have been occurring in parallel as described below may continue.

At block 1265, the session may be closed as previously indicated.

In some implementations, actions associated with various blocks of FIG. 12 may proceed in parallel. For example, after sending some of the meta-data at block 1245, a request for more meta-data may be received at block 1240 while the actions associated with blocks 1250-1260 are also performed.

In an embodiment, after an upstream machine sends a first or other batch of meta-data at block 1245, the upstream machine may again receive a request for notification of updates (e.g., the actions associated with block 1220) while performing actions associated with blocks 1240, 1250, and 1255. The upstream machine may be performing one or more of the actions associated with blocks 1220-1240 while also performing one or more of the actions associated with blocks 1245-1255.

The upstream machine may also receive and service in parallel requests from multiple downstream machines thus causing actions to occur in parallel.

Furthermore, some of the actions may be omitted in embodiments. For example, in one embodiment, a downstream machine may request that the upstream machine send a version vector without sending a notification whenever updates occur on the upstream machine. In this case, the actions associated with blocks 1220 and 1225 may be omitted. This may be useful as has been described above.

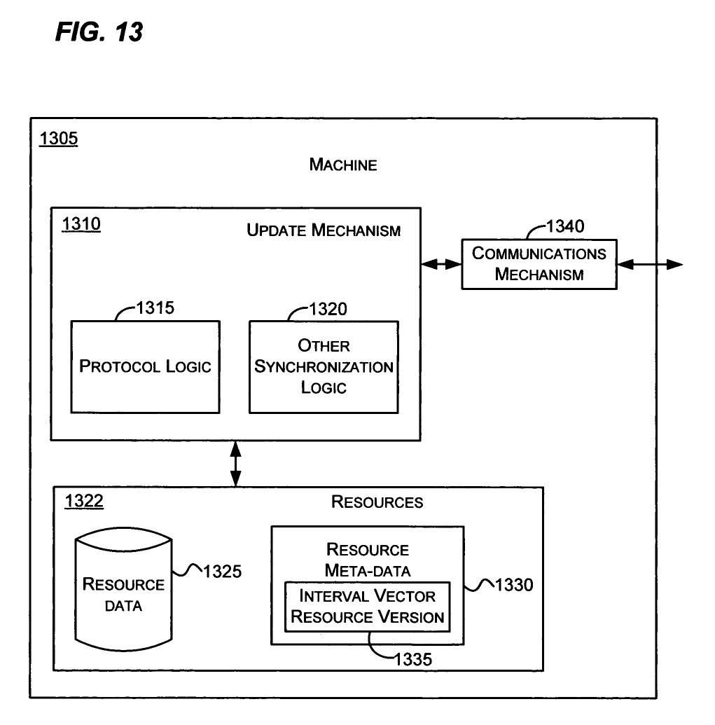

FIG. 13 is a block diagram representing a machine configured to operate in a resource replication system in accordance with aspects of the subject matter described herein. The machine 1305 includes an update mechanism 1310, resources 1322, and a communications mechanism 1340.

The update mechanism 1310 includes protocol logic 1315 that operates as described previously. The other synchronization logic 1320 includes synchronization logic other than the protocol logic (.e.g., what to do in case of conflicting updates, how to determine which updates to obtain, and so forth). Although the protocol logic 1315 and the other synchronization logic 1320 are shown as separate boxes, they may be combined in whole or in part.

The resources 1322 include the objects store 1325 for storing resource data and the resource meta-data store 1330. Although shown in the same box, the resource data store 1325 may be stored together or in a separate store relative to the resource meta-data store 1330 Among other things, the resource meta-data store 1330 may include versions for each of the resource data records stored in the resource store 1325 and may also include an interval vector (block 1335).

The communications mechanism 1340 allows the update mechanism 1310 to communicate with other update mechanisms (not shown) on other machines. The communications mechanism 1340 may be a network interface or adapter 170, modem 172, or any other means for establishing communications as described in conjunction with FIG. 1.

It will be recognized that other variations of the machine shown in FIG. 13 may be implemented without departing from the spirit or scope of the subject matter described herein.

Following are some exemplary interfaces may be used by upstream and downstream machines to perform aspects described herein:

```
RequestVvUp // Request upstream version vector or change
  notification:
    [in] contentSetId // The content set to get the updates
    [in] changeType ∈ { CHANGE_NOTIFY, CHANGE_DELTA,
CHANGE_ALL }
    [in] vvGeneration // Timestamp of last version vector
known to downstream
    [out] vvUp // Upstream version vector
RequestUpdates // Request updates from upstream
    [in] contentSetId // The content set to get the updates
    [in] creditsAvailable // Limit to number of updates to
receive
    [in] updateRequestType ∈ { ALL, TOMBSTONES, LIVE }
    [in] vvDiff // Delta version vector
    [out] updates[creditsUsed] // Array of updates
    [out] updateStatus ∈ { DONE, MORE, WAIT }
    [out] Offset // Cursor, how far did upstream get in
processing updates
```

It will be recognized, however, that more, fewer, or different interfaces may be used or that the interfaces above may have more, fewer, or different parameters without departing from the spirit or scope of the subject matter described herein.

Furthermore, the syntax used to describe the interface above is not intended to limit implementations to Remote Procedure Call (RPC) communications. Rather, the syntax is used to describe some parameters that may be used to implement aspects of the subject matter described herein. Indeed, any mechanism for communicating between machines (RPC, sockets, HTTP, e-mail, network messages of other types, some combination of the above, and the like) may be used to transmit the parameters without departing from spirit or scope of the subject matter described herein.

As can be seen from the foregoing detailed description, aspects have been described related to replicating resources. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, comprising:
requesting notification of updates to a replica set that occur on an upstream machine;
receiving notification that updates to the replica set have occurred on the upstream machine;
requesting meta-data regarding the updates, wherein the meta-data includes attributes for synchronizing local resources with resources residing on the upstream machine; and
requesting data associated with at least one of the resources based at least in part on the meta-data and local resources.

2. The computer-readable medium of claim 1, further comprising requesting a version vector from the upstream machine, wherein the version vector represents knowledge of the upstream machine regarding latest versions of resources in the replica set.

3. The computer-readable medium of claim 1, wherein requesting meta-data regarding the updates comprises sending a parameter that indicates a maximum number of records of the meta-data to return.

4. The computer-readable medium of claim 3, further comprising receiving a second number of records of the meta-data together with a value that represents an offset into the meta-data, wherein the offset indicates a last record the upstream machine reached in sending the meta-data.

5. The computer-readable medium of claim 4, further comprising sending the offset in another request to obtain additional records of the meta-data.

6. The computer-readable medium of claim 1, wherein a single connection is used for a synchronization between the upstream machine and local resources for a plurality of replica sets including the replica set.

7. The computer-readable medium of claim 1, wherein requesting notification of updates to a replica set that occur on an upstream machine comprises requesting that a version vector associated with the upstream machine is sent when updates have occurred on the upstream machine, and wherein receiving notification that updates to the replica set have occurred on the upstream machine comprises receiving the version vector.

8. A method implemented at least in part by a machine, comprising:
receiving a first request for notification of updates that occur to a first data store;
providing the notification after an update occurs to the first data store;
receiving a second request for meta-data regarding the update, wherein the meta-data includes attributes for use in determining whether data associated with a resource of the first data store needs to be sent to a second data store to synchronize the second data store with the first data store; and
in response to the second request, providing at least some of the meta-data.

9. The method of claim 8, further comprising:
receiving a third request for a version vector, wherein the version vector represents knowledge regarding latest versions of resources in the replica set that reside on the first data store; and
in response to the third request, providing the version vector.

10. The method of claim 9, further comprising refraining from sending the version vector until after the third request is received.

11. The method of claim 8, wherein the second request includes a parameter that indicates an amount of meta-data to provide in response to the second request.

12. The method of claim 11, further comprising providing an offset that indicates a position in the meta-data that was reached in providing at least some of the meta-data.

13. The method of claim 12, further comprising:
receiving a third request that includes the offset; and
in response to the third request, providing more of the meta-data starting at the offset.

14. The method of claim 11, further comprising indicating that all of the meta-data has been provided.

15. The method of claim 8, wherein the method defines at least part of a communication protocol between at least two machines.

16. At least one computer-readable medium containing instructions which when executed by a computer, perform actions, comprising:
at an interface, receiving an instruction to provide meta-data associated with updates to resources involved in a replica set, wherein the meta-data includes attributes for synchronizing resources in at least two data stores, and wherein the instruction is associated with a value that indicates a maximum amount of the meta-data to provide; and
in response thereto, attempting to locate at least some of the meta-data up to the maximum amount and providing the at least some of the meta-data if located.

17. The at least one computer-readable medium of claim 16, wherein the instruction includes a delta version vector that indicates which resources have been updated.

18. The at least one computer-readable medium of claim 16, further comprising providing an offset that indicates a position in the meta-data that was reached in providing at least some of the meta-data.

19. The at least one computer-readable medium of claim 18, further comprising:
at the interface, receiving the offset with another instruction to provide the meta-data; and
in response thereto, locating more of the meta-data up to the maximum amount based at least in part on the offset.

20. The at least one computer-readable medium of claim 16, wherein the value that indicates a maximum amount of the meta-data to provide is received at the interface together with the instruction.
